(19) United States
(12) Patent Application Publication
(10) Pub. No.: US 2013/0201682 A1
(43) Pub. Date: Aug. 8, 2013

(54) LAMPSHADE AND LED LAMP USING THE SAME

(71) Applicants: Shih-Ting CHIU, CHIAYI (TW); Chien-Wen CHIU, CHIAYI (TW)

(72) Inventors: Shih-Ting CHIU, CHIAYI (TW); Chien-Wen CHIU, CHIAYI (TW)

(73) Assignee: BEAUTIFUL LIGHT TECHNOLOGY CORP., CHIAYI (TW)

(21) Appl. No.: 13/444,854

(22) Filed: Apr. 12, 2012

(30) Foreign Application Priority Data
Feb. 4, 2012 (TW) 101103689

(51) Int. Cl. F21V 1/12; B29C 45/00

(52) U.S. Cl. 362/235; 362/360; 264/328.1

(57) ABSTRACT

A lampshade and a light-emitting diode (LED) lamp using the same are provided. The lamp includes a lampshade main portion having a curved surface, and a radian of the curved surface of the lampshade main portion is greater than that of a semisphere. The lampshade main portion includes a plurality of lampshade plates. Each of the lampshade plates has a curved surface, and a radian of the curved surface of each of the lampshade plates is less than or equal to that of a semisphere. The lamp includes a base, the lampshade, and light-emitting diodes (LCDs). The lampshade is disposed on the base to form an accommodating space. The LEDs are disposed in the accommodating space to enable the light emitted by the LEDs to be diffused to outside of the LED lamp through the lampshade.

### RELATED APPLICATIONS

This application claims priority to Taiwan Application Serial Number 101103689, filed Feb. 4, 2012, which is herein incorporated by reference.

### FIELD OF THE INVENTION

The present invention relates to a lampshade and a lamp using the same, and more particularly to a combination type lampshade and a lamp using the same.

### BACKGROUND OF THE INVENTION

Because the luminous efficiency of a conventional incandescent light bulb is poor, the incandescent light bulb is very likely to be prohibited in various countries of the world under environmental protection and energy saving trends. A light-emitting diode (LED) has great potential for substituting the incandescent light bulb. A light emission angle of the incandescent light bulb can reach to about 300 degrees (the light emission angle is estimated by using an angle range developed by the light with half of the maximum light intensity). A conventional LED has a Lambertion light field distribution, and thus a LED lamp constructed from a plurality of LEDs has a small light-outputting angle because of the Lambertion light field distribution, and when the LED lamp is used in a bigger space, it is very difficult for the LED lamp to achieve a uniform (omnidirectional) illumination distribution. Therefore, the LED lamp may not only cause a problem of direct glare but also cause the generation of light speckles, thus limiting the speed of substituting the incandescent light bulb with the LED lamp.

In a current LED lamp, the light emitted by LEDs is uniformly diffused by a lampshade having light-diffusion function to increase the light emission angle of the LED lamp. Because the present lampshade is fabricated by using injection-molding technology, a corresponding mold (for example, a shell having a radian greater than that of a semisphere) is needed when the lampshade is bigger than a semisphere (e.g., the radian of the lampshade is greater than that of a semisphere). However, with respect to the injection molding technology, it is very difficult to fabricate a mold bigger than a semisphere. Therefore, the injection molding technology can be only applied for fabricating a mold used for a lamp smaller than a semisphere.

Because the semisphere lampshade merely provides a light emission angle of a semisphere surface, it is very difficult to achieve a great light emission angle for a LED lamp applying the semisphere lampshade. However, the cost of the lamp and the lampshade are increased when other manufacturing technology is applied to fabricate the lampshade bigger than a semisphere.

Therefore, there is a need for a new lampshade and a LED lamp using the new lampshade having lower fabrication cost.

### SUMMARY OF THE INVENTION

Therefore, one aspect of the present invention is to provide a lampshade and a LED lamp using the same. The lampshade is constructed by a plurality of lampshade plates, and a radian of each of the lampshade plates is not greater than that of a semisphere, so that the low cost injection molding technology can be used to fabricate the lampshade and the lamp.

According to one embodiment of the present invention, the lampshade includes a lampshade main portion. The lampshade main portion has a first curved surface. The radian of the first curved surface is greater than that of a second curved surface belonging to a semisphere. The lampshade main portion includes a plurality of lampshade plates, and each of the lampshade plates has a third curved surface having a radian smaller than or equal to that of the second curved surface.

According to another embodiment of the present invention, the lamp includes a seat, a lampshade, and at least one light-emitting diode. The lampshade is disposed on the seat to form an accommodating space with the seat, wherein the lampshade includes a lampshade main portion. The lampshade main portion has a first curved surface. The radian of the first curved surface is greater than that of a second curved surface belonging to a semisphere. The lampshade main portion includes a plurality of lampshade plates, and each of the lampshade plates has a third curved surface having a radian smaller than or equal to that of the second curved surface. The at least one light-emitting diode is disposed in the accommodating space to enable the light emitted by the LEDs to be diffused to outside of the LED lamp through the lampshade.

As described above, the lampshade of the embodiment of the present invention is constructed by a plurality of lampshade plates, and a radian of each of the lampshade plates is not greater than that of a semisphere, so that the low cost injection molding technology can be used to fabricate the lampshade and the lamp. When the lampshade plates are combined, a lampshade having a radian grater than that of a semisphere is accomplished.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawings, wherein:

FIG. 1 is a schematic diagram showing a side sectional view of a light-emitting diode (LED) lamp in accordance with an embodiment of the present invention;

FIG. 2 is an explosion diagram showing a LED lamp in accordance with an embodiment of the present invention;

FIG. 3 is an explosion diagram showing a LED lamp in accordance with another embodiment of the present invention;

FIG. 4 is an explosion diagram showing a LED lamp in accordance with another embodiment of the present invention;

FIG. 5 is an explosion diagram showing a LED lamp in accordance with another embodiment of the present invention; and

FIG. 6 is an explosion diagram showing a LED lamp in accordance with another embodiment of the present invention.

### DETAILED DESCRIPTION OF THE PREFERRED EMBODIMENT

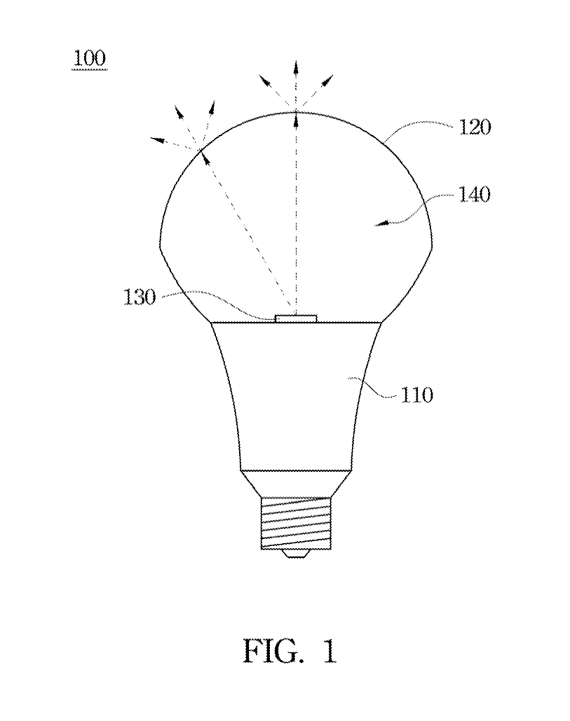

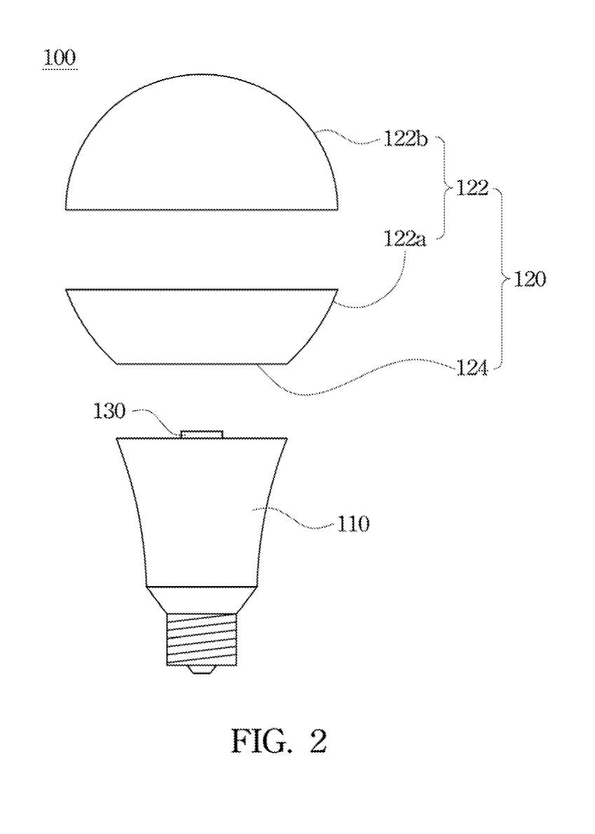

Refer to FIG. 1 and FIG. 2 simultaneously. FIG. 1 is a schematic diagram showing a side sectional view of a light-emitting diode (LED) lamp 100 in accordance with an embodiment of the present invention. FIG. 2 is an explosion diagram showing the LED lamp 100 in accordance with the embodiment of the present invention. The LED lamp 100 includes a seat 110, a lampshade 120, and a LED 130, wherein the LED 130 may be a capsulated LED chip, and the number of the LED 130 is not limited to one. In the other embodiment of the present invention, the LED lamp 100 may include a plurality of LEDs 130. The lampshade 120 is disposed on the seat 110 to form an accommodating space with the seat 110 for receiving the LED 130, so that the light emitted by the LED 130 is diffused to outside of the lamp 100 through the lampshade 120.

In this embodiment, the lampshade 120 includes a lampshade main portion 122 and a connection portion 124. The lampshade main portion 122 includes a rear lampshade plate 122a and a front lampshade plate 122b combined in a vertical direction, and a bottom edge of the rear lampshade plate 122b has the connection portion 124, so that the lampshade main portion 122 can be disposed on the seat 110 through the connection portion 124. In this embodiment, the connection between the connection portion 124 and the seat 110 is implemented by embedment mechanism (for example, tenons or lead screws), thereby embedding the connection portion 124 on the seat 110. In addition, in the other embodiment of the present invention, the lampshade main portion 122 can be disposed on the seat 110 by using adhesives, and thus the connection portion 124 is not necessary.

The rear lampshade plate 122a and the front lampshade plate 122b are fabricated by using injection molding technology, wherein the material of the rear lampshade plate 122a and the front lampshade plate 122b can be a polymer (for example, a polycarbonate (PC)), but the embodiments of the present invention are not limited thereto.

It can be understood from FIG. 2 that a radian of a curved surface of the front lampshade plate 122b is substantially equal to that of a curved surface of a semisphere, and a radian of a curved surface of the rear lampshade plate 122a is substantially smaller than a curved surface of a semisphere. When, the front lampshade plate 122b is combined with the rear lampshade plate 122a, the lampshade main portion 122 having a surface radian greater than that of a semisphere is formed, thereby enabling the LED lamp 100 to has greater light-emission angle. In the embodiments of the present invention, the combination of the front lampshade plate 122b and the rear lampshade plate 122a is implemented by using the adhesives or the embedment mechanism, but the embodiments of the present invention are not limited thereto.

In addition, although the surface radian of the rear lampshade plate 122a of this embodiment is smaller than that of a semisphere, the embodiments of the present invention are not limited thereto. In other embodiments of the present invention, the surface radian of the rear lampshade plate 122a can be designed to be substantially equal to the surface radian of a semisphere, and a bottom surface of the rear lampshade plate 122a may have a small hole to allow the LED 130 to pass through the rear lampshade plate 122a.

It can be understood from the above description that the lampshade 120 of this embodiment is constructed by the front lampshade plate 122b and the rear lampshade plate 122a. Because the surface radian of each of the front lampshade plate 122b and the rear lampshade plate 122a is not greater than the surface radian of a semisphere, the front lampshade plate 122b and the rear lampshade plate 122a can be fabricated by using low cost injection molding technology, and the lampshade 120 having a surface radian greater than the surface radian of a semisphere is then provided to enable the light emitted by the LED 130 to be emitted in a wider emission angle.

It is noted that because the lampshade 120 is constructed by the rear lampshade plate 122a and the front lampshade plate 122b, the rear lampshade plate 122a and the front lampshade plate 122b can be designed to have different optic properties (for example, refractive indexes or colors . . . etc), and thus patterns and qualities of the output light of the LED lamp 100 can be adjusted through the change of the optic properties to meet demands of different users.

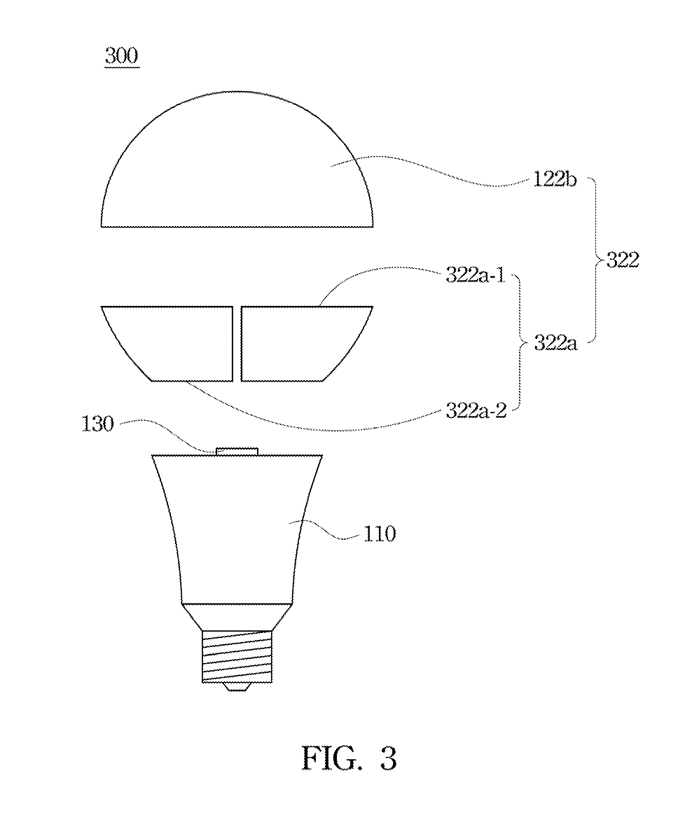

Refer to FIG. 3. FIG. 3 is an explosion diagram showing a LED lamp 300 in accordance with another embodiment of the present invention. The LED lamp 300 is similar to the LED lamp 100, but the difference is in that a lampshade main portion 322 of the LED lamp 300 is constructed by the front lampshade plate 122b and a rear lampshade plate 322a, and the rear lampshade plate 322a is constructed by a sub lampshade plate 322a-1 and a sub lampshade plate 322a-2.

In this embodiment, each of the surface radians of the sub lampshade plate 322a-1 and the sub lampshade plate 322a-2 is smaller than or equal to the surface radian of the a quarter of a sphere, so that the rear lampshade plate 322a constructed by the sub lampshade plate 322a-1 and the sub lampshade plate 322a-2 has a shapes similar to the shape of the rear lampshade plate 122a.

Because the rear lampshade plate 322a is constructed by the sub lampshade plate 322a-1 and the sub lampshade plate 322a-2, the sub lampshade plate 322a-1 and the sub lampshade plate 322a-2 can be designed to have different optic properties (for example, refractive indexes or colors . . . etc), and thus patterns and qualities of the output light of the LED lamp 300 can be adjusted through the change of the optic properties to meet demands of different users.

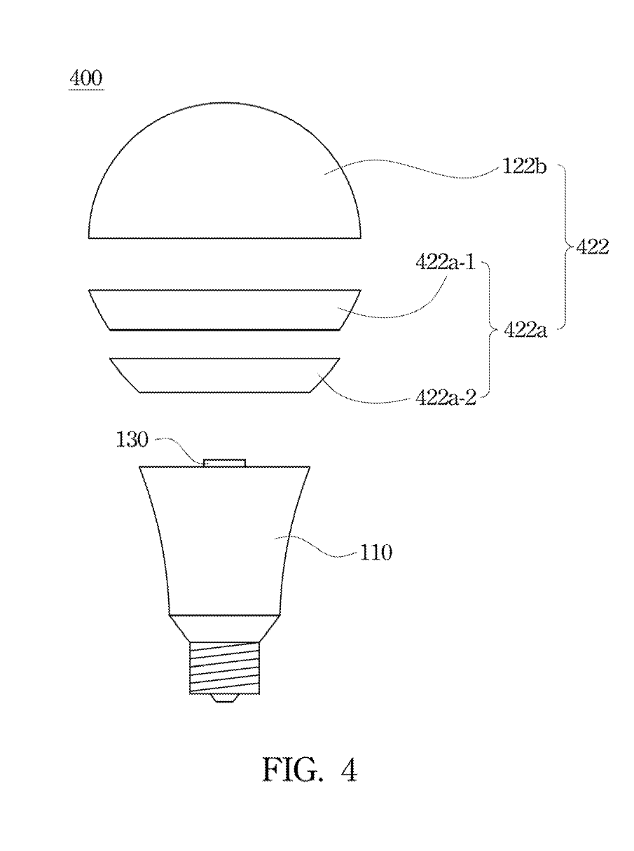

Refer to FIG. 4. FIG. 4 is an explosion diagram showing a LED lamp 400 in accordance with another embodiment of the present invention. The LED lamp 400 is similar to the LED lamp 300, but the difference is in that a rear lampshade plate 422a of a lampshade main portion 422 of the LED lamp 400 is constructed by a sub lampshade plate 422a-2 and a sub lampshade plate 422a-1 combined in a vertical direction, wherein each of the surface radians of the sub lampshade plate 422a-1 and the sub lampshade plate 422a-2 is not greater than the surface radian of a semisphere.

Because the rear lampshade plate 422a is constructed by the sub lampshade plate 422a-2 and the sub lampshade plate 422a-1 combined in a vertical direction, the sub lampshade plate 422a-1 and the sub lampshade plate 422a-2 can be designed to have different optic properties (for example, refractive indexes or colors . . . etc), and thus patterns and qualities of the output light of the LED lamp 400 can be adjusted through the change of the optic properties to meet demands of different users.

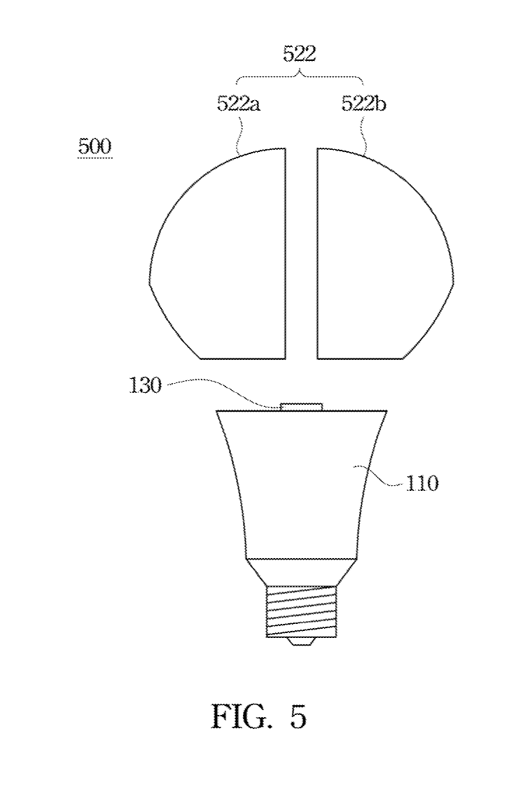

Refer to FIG. 5. FIG. 5 is an explosion diagram showing a LED lamp 500 in accordance with another embodiment of the present invention. The LED lamp 500 is similar to the LED lamp 100, but the difference is in that a lampshade plate 522a and a lampshade plate 522b of a lampshade main portion 522 of the LED lamp 500 are combined in a horizontal direction to form the lampshade main portion 522, wherein each of the surface radians of the lampshade plate 522a and the lampshade plate 522b is substantially smaller than or equal to that of a semisphere.

Because the lampshade main portion 522 is constructed by the lampshade plate 522a and the lampshade plate 522b combined in a horizontal direction, the lampshade plate 522a and the lampshade plate 522b can be designed to have different optic properties (for example, refractive indexes or colors . . . etc), and thus patterns and qualities of the output light of the LED lamp 500 can be adjusted through the change of the optic properties to meet demands of different users.

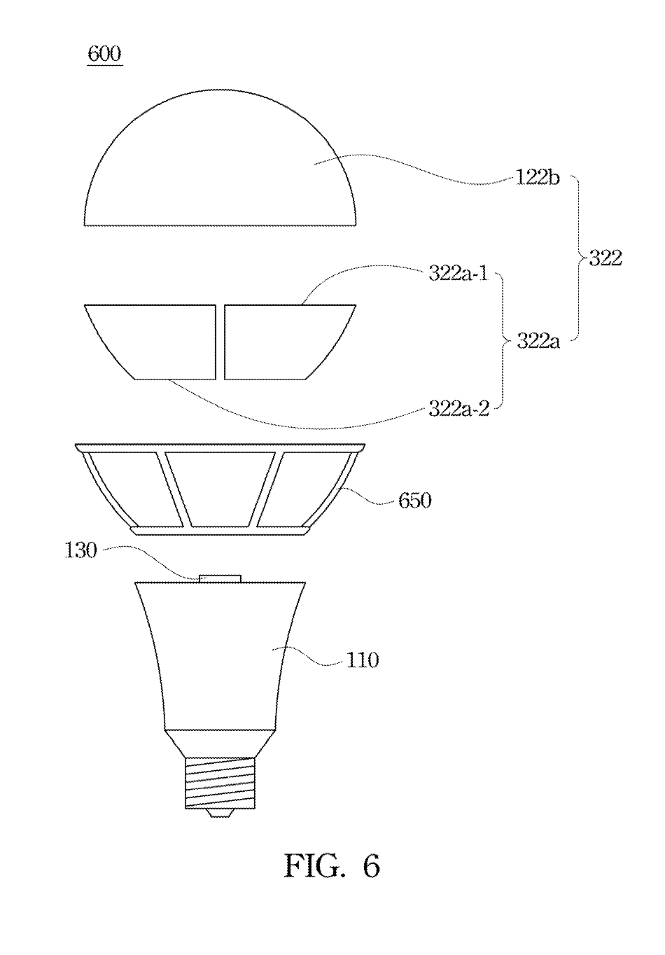

Refer to FIG. 6. FIG. 6 is an explosion diagram showing a LED lamp 600 in accordance with another embodiment of the present invention. The LED lamp 600 is similar to the LED lamp 300, but the difference is in that the lamp 600 further includes a lampshade frame 650 surrounding the lampshade of lamp 600.

The lampshade frame 650 of this embodiment is made by a material with high strength and thermal conductivity (for example, a metal), and has a hollow structure, thereby increasing the thermal dissipation and the mechanical strength of the lamp 600 and preventing the light-emission angle of the lamp 600 from being greatly restricted by the lampshade frame 650.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A lampshade, comprising:
a lampshade main portion, having a first curved surface, wherein the radian of the first curved surface is greater than that of a second curved surface belonging to a semisphere, and the lampshade main portion comprises a plurality of lampshade plates, and each of the lampshade plates has a third curved surface having a radian smaller than or equal to that of the second curved surface.

2. The lampshade according to claim 1, wherein the lampshade main portion comprises:
a rear lampshade plate, having a third curved surface, wherein a radian of the third curved surface is smaller than or equal to that of the second curved surface; and
a front lampshade plate, disposed on the rear lampshade plate and having a fourth curved surface, and a radian of the fourth curved surface is equal to that of the second curved surface.

3. The lampshade according to claim 2, wherein the rear lampshade plate comprises two sub lampshade plates, and each of the sub lampshade plates has a fifth curved surface, and a radian of the fifth curved surface is smaller than or equal to that of the second curved surface of a quarter of a sphere.

4. The lampshade according to claim 1, wherein the material of the lampshade plates is a polymer.

5. The lampshade according to claim 1, wherein the lampshade plates are fabricated by using injection molding technology.

6. A lamp, comprising:
a seat;
a lampshade, disposed on the seat to form an accommodating space with the seat, wherein the lampshade comprises:
a lampshade main portion, having a first curved surface, wherein the radian of the first curved surface is greater than that of a second curved surface belonging to a semisphere, and the lampshade main portion comprises a plurality of lampshade plates, and each of the lampshade plates has a third curved surface having a radian smaller than or equal to that of the second curved surface; and
at least one light-emitting diode, disposed in the accommodating space to enable the light emitted by the at least one light-emitting diode to be diffused to outside of the lamp through the lampshade.

7. The lamp according to claim 6, wherein the lampshade main portion comprises:
a rear lampshade plate, having a third curved surface, wherein a radian of the third curved surface is smaller than or equal to that of the second curved surface; and
a front lampshade plate, disposed on the rear lampshade plate and having a fourth curved surface, and a radian of the fourth curved surface is equal to that of the second curved surface.

8. The lamp according to claim 7, wherein the rear lampshade plate comprises two sub lampshade plates, and each of the sub lampshade plates has a fifth curved surface, and a radian of the fifth curved surface is smaller than or equal to that of the second curved surface of a quarter of a sphere.

9. The lamp according to claim 6, wherein the material of the lampshade plates is a polymer, and the lampshade plates are fabricated by using injection-molding technology.

10. The lamp according to claim 6, further comprising a lampshade frame disposed on the seat to enable the lampshade main portion to be fixed on the seat.
